(19) United States
(12) Patent Application Publication
(10) Pub. No.: US 2024/0173739 A1
(43) Pub. Date: May 30, 2024

(54) COATING APPARATUS

(71) Applicant: TOYOTA JIDOSHA KABUSHIKI KAISHA, Toyota-shi (JP)

(72) Inventors: Noriyuki KATO, Nagoya-shi (JP); Katsumi NAGAI, Nisshin-shi (JP); Katsushi ENOKIHARA, Toyota-shi (JP); Kiminori UNNO, Hamamatsu-shi (JP); Kenji KOURA, Toyota-shi (JP); Takeshi KONDO, Kariya-shi (JP)

(73) Assignee: TOYOTA JIDOSHA KABUSHIKI KAISHA, Toyota-shi (JP)

(21) Appl. No.: 18/488,507

(22) Filed: Oct. 17, 2023

(30) Foreign Application Priority Data
Nov. 30, 2022 (JP) 2022-191464

(51) Int. Cl. B05C 5/02

(52) U.S. Cl. CPC B05C 5/0275; B05C 5/0225; B05C 5/0245

(57) ABSTRACT

A coating apparatus includes: a coating manifold for supplying a coating liquid to a base material; a supply channel for supplying the coating liquid to the coating manifold; and a connection channel connecting the supply channel to the coating manifold. The connection channel includes at least one branch portion, and the at least one branch portion branches into two branch channels that are equal to each other in channel distance.

This nonprovisional application is based on Japanese Patent Application No. 2022-191464 filed on Nov. 30, 2022 with the Japan Patent Office, the entire contents of which are hereby incorporated by reference.

### BACKGROUND

### Field

The present disclosure relates to a coating apparatus.

### Description of the Background Art

Japanese Patent Application Laid-Open No. 2022-41501 discloses a coating apparatus including a first manifold, a plurality of second channels connected to the first manifold, and a die including a second manifold connected to the plurality of second channels. A coating liquid is supplied from a tank to the first manifold. The first manifold has a function of uniformly supplying the coating liquid to each of the second channels. The second manifold has a function of adjusting the pressure of the coating liquid in the width direction. The coating liquid flowing out from the second manifold is discharged from the discharge port of the die toward the base material.

### SUMMARY

In the coating apparatus described in Japanese Patent Application Laid-Open No. 2022-41501, since the channel distances from the upstream end of the first manifold to the second manifold via the respective second channels are different from each other, the pressure loss distribution becomes uneven. Further, since the shear velocity distribution in the first manifold is uneven, stagnation occurs in the first manifold. For this reason, the flow rate distribution in the width direction varies, for example, during intermittent coating or when the viscosity of the coating liquid changes. As a result, the thickness of the coating liquid discharged from the second manifold varies.

It is an object of the present disclosure to provide a coating apparatus capable of suppressing a variation in a flow rate distribution in a width direction of a coating liquid flowing out from a coating manifold.

A coating apparatus according to one aspect of the present disclosure is a coating apparatus for forming a coating film on a base material by supplying a coating liquid to the base material, the coating apparatus includes: a coating manifold for supplying the coating liquid to the base material; a supply channel for supplying the coating liquid to the coating manifold; and a connection channel connecting the supply channel to the coating manifold, the connection channel includes at least one branch portion, and the at least one branch portion is branched into two branch channels that are equal to each other in channel distance.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view schematically showing a coating apparatus according to an embodiment of the present disclosure.

FIG. 2 is a perspective view schematically showing a coating apparatus.

FIG. 3 is a diagram schematically showing a connection channel.

FIG. 4 is a diagram schematically showing a modified example of the connection channel.

FIG. 5 is a diagram schematically showing a modified example of the connection channel.

### DESCRIPTION OF THE PREFERRED EMBODIMENTS

Embodiments of the present disclosure will be described with reference to the drawings. In the drawings referred to below, the same or corresponding members are denoted by the same reference numerals.

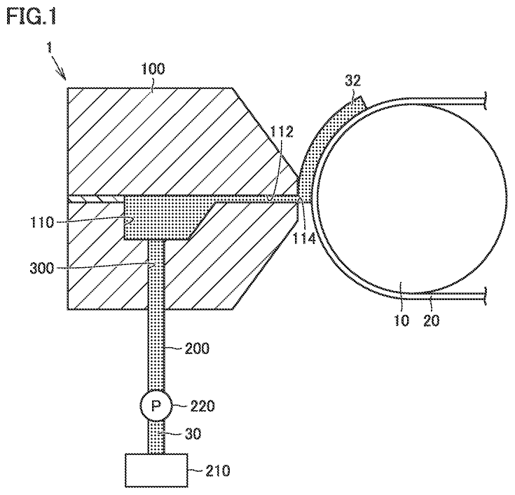

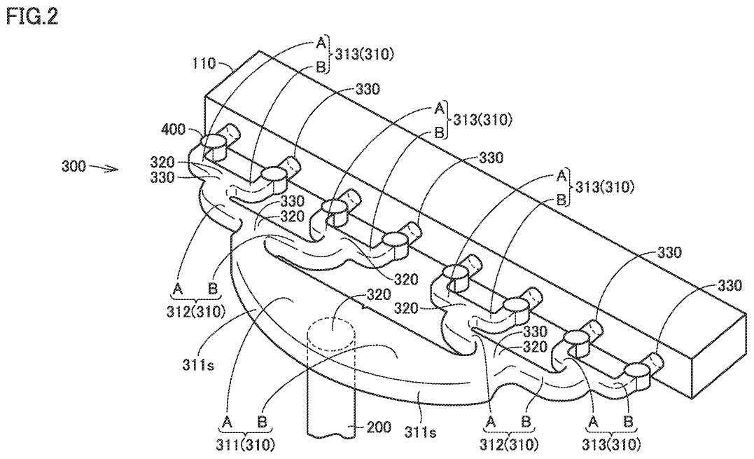

FIG. 1 is a cross-sectional view schematically showing a coating apparatus according to an embodiment of the present disclosure. FIG. 2 is a perspective view schematically showing a coating apparatus. The coating apparatus 1 is an apparatus for coating a coating liquid 30 on a base material 20 conveyed by a roll 10. In the present embodiment, a slurry used for an electrode of a power storage cell is used as the coating liquid 30, and an electrode foil made of aluminum or the like is used as the base material 20. However, the base material 20 and the coating liquid 30 are not limited thereto.

As shown in FIGS. 1 and 2, the coating apparatus 1 includes a die 100, a supply channel 200, a connection channel 300, and a flow control valve 400.

The die 100 applies (supplies) the coating liquid 30 to the base material 20. The die 100 includes a coating manifold 110. The coating manifold 110 has a function of discharging the coating liquid 30 with a uniform thickness in a width direction (a direction parallel to the rotation axis of the roll 10) with respect to the base material 20.

The die 100 has a slit portion 112 connected to the outlet of the coating manifold 110, and a discharge port 114 connected to the slit portion 112. The coating liquid 30 flowing out from the coating manifold 110 is discharged from the discharge port 114 to the base material 20 through the slit portion 112. Thereby, a coating film 32 (see FIG. 1) is formed on the base material 20.

The supply channel 200 is a channel for supplying the coating liquid 30 to the coating manifold 110. The coating liquid 30 is sent from a tank 210 storing the coating liquid 30 to the supply channel 200 by a pump 220.

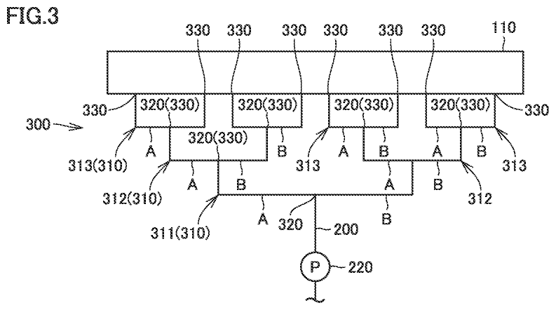

The connection channel 300 connects the supply channel 200 and the coating manifold 110. The connection channel 300 has a function of leveling the coating liquid 30 flowing into the coating manifold 110 in the width direction. The connection channel 300 has at least one branch portion 310. In FIGS. 2 and 3, seven branch portions 310 are shown. However, the number of the branch portions 310 is not limited to 7. In FIG. 1, the connection channel 300 is simply shown as a single channel.

The branch portion 310 has a shape that branches into two branch channels A and B whose channel distances are equal to each other. That is, the branch portion 310 has one upstream end portion 320 and two downstream end portions 330. The two branch channels A and B have a first branch channel A and a second branch channel B. The upstream end of the first branch channel A and the upstream end of the second branch channel B constitute the upstream end portion 320. The downstream end of the first branch channel A and the downstream end of the second branch channel B constitute the downstream end portions 330. The channel distance means the length of the central axis of each of the branch channels A and B. FIG. 3 shows the central axes of the branch channels A and B.

Hereinafter, the branch portion 310 connected to the downstream end of the supply channel 200 is denoted as “first branch portion 311”, the branch portion 310 connected to each downstream end portion 330 of the first branch portion 311 is denoted as “second branch portion 312”, and the branch portion 310 connected to each downstream end portion 330 of the second branch portion 312 is denoted as “third branch portion 313”. In the embodiment shown in FIGS. 2 and 3, the connection channel 300 includes one first branch portion 311, two second branch portions 312, and four third branch portions 313.

The first branch portion 311 branches from the supply channel 200. The upstream end portion 320 of the first branch portion 311 is connected to the downstream end of the supply channel 200. The first branch portion 311 receives the coating liquid 30 sent from the supply channel 200. The first branch portion 311 has an outer shape larger than a diameter of a downstream end of the supply channel 200. In the present embodiment, the first branch portion 311 is disposed above the supply channel 200. However, the first branch portion 311 may be disposed below the supply channel 200, or the first branch portion 311 and the supply channel 200 may be disposed substantially in the same plane.

As shown in FIG. 2, the first branch portion 311 has a guide surface 311s having a shape gradually approaching the coating manifold 110 toward the outside in the width direction. The guide surface 311s is curved.

Each second branch portion 312 branches from the first branch portion 311. The upstream end portion 320 of the second branch portion 312 is connected to the downstream end portion 330 of the first branch portion 311.

Each third branch portion 313 branches from the second branch portion 312. The upstream end portion 320 of the third branch portion 313 is connected to the downstream end portion 330 of the second branch portion 312. In the present embodiment, each of the third branch portions 313 is provided with a flow control valve 400. However, the flow control valve 400 may be provided in the second branch portion 312.

As described above, the branch channels A and B are formed to have the same channel distance. That is, in each of the branch portions 311 to 313, the channel distance between the upstream end portion 320 and one of the two downstream end portions 330 is equal to the channel distance between the upstream end portion 320 and the other of the two downstream end portions 330.

As described above, in the coating apparatus 1 according to the present embodiment, since the branch portion 310 is branched into two branch channels A and B having equal channel distances, the pressure loss distribution in the branch portion 310 is made uniform. Therefore, variation in the flow rate distribution in the width direction of the coating liquid 30 flowing out from the coating manifold 110 is suppressed. Accordingly, during intermittent coating or the like, the coating liquid 30 supplied to the connection channel 300 and the coating manifold 110 is discharged first.

Further, since the first branch portion 311 has the guide surface 311s, the occurrence of stagnation of the coating liquid 30 in the first branch portion 311 is suppressed.

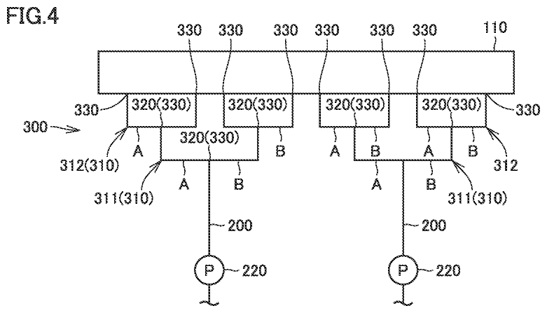

As shown in FIG. 4, the coating apparatus 1 may have two or more supply channels 200. In this case, the connection channel 300 connects the supply channels 200 and the coating manifold 110. In this case, the pump 220 is provided in each supply channel 200.

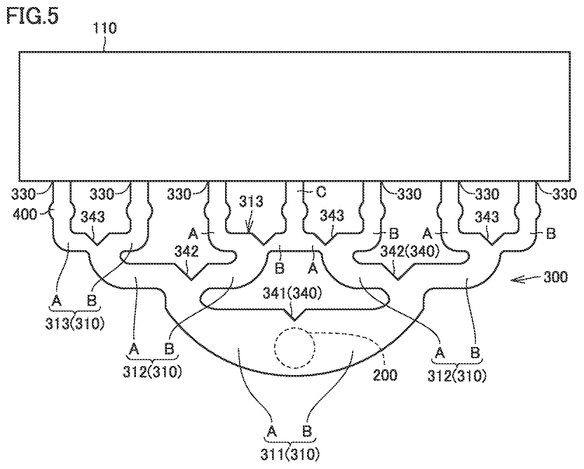

In the above-described embodiment, as shown in FIG. 5, the branch portion 310 may have a junction channel C. In the example shown in FIG. 5, among the four third branch portions 313, a pair of third branch portions 313 at the center has a junction channel C. Specifically, the second branch channel B in one of the pair of third branch portions 313 and the first branch channel A in the other of the pair of third branch portions 313 are merged to form a merged channel C. In this example, the number of downstream end portions 330 is 7.

In the example shown in FIG. 5, it is preferable that the flow rate adjusting portion 340 is formed at each upstream end portion 320. The flow rate adjusting portion 340 adjusts the flow rates of the branch channels A and B. The flow rate adjusting portion 340 includes a first adjusting portion 341 formed at the upstream end portion 320 of the first branch portion 311, a second adjusting portion 342 formed at the upstream end portion 320 of the second branch portion 312, and a third adjusting portion 343 formed at the upstream end portion 320 of the third branch portion 313. Each of the adjusting portions 341 to 343 includes a notch. Each of the adjusting portions 341 to 343 is formed at a position where the coating liquid 30 is evenly distributed to the downstream end portions 330 of each of the third branch portions 313. Note that the flow rate adjusting portion 340 may be configured by a three-way valve, but by being configured by a notch, it is possible to adjust the flow rate while reducing the occurrence of pressure loss.

It will be appreciated by those skilled in the art that the exemplary embodiments described above are specific examples of the following aspects.

### Aspect 1

A coating apparatus for forming a coating film on a base material by supplying a coating liquid to the base material, the coating apparatus including:
a coating manifold for supplying the coating liquid to the base material;
a supply channel for supplying the coating liquid to the coating manifold; and
a connection channel connecting the supply channel to the coating manifold, wherein
the connection channel includes at least one branch portion, and
the at least one branch portion branches into two branch channels that are equal to each other in channel distance.

In this coating apparatus, the branch portion is branched into two branch channels having respective channel distances equal to each other, and therefore, the distribution of pressure loss in the branch portion is made uniform. Therefore, variation in the flow rate distribution in the width direction of the coating liquid flowing out from the coating manifold is suppressed. The channel distance is the length of the central axis of each branch channel.

### Aspect 2

The coating apparatus according to Aspect 1, wherein
the at least one branch portion includes:
   one upstream end portion forming an upstream end of each of the two branch channels; and
   two downstream end portions forming respective downstream ends of the two branch channels, respectively, and
a channel distance between the upstream end portion and one of the two downstream end portions is equal to a channel distance between the upstream end portion and the other of the two downstream end portions.

### Aspect 3

The coating apparatus according to Aspect 2, wherein the upstream end portion is provided with a flow rate adjusting portion that adjusts a flow rate of each of the two branch channels.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A coating apparatus for forming a coating film on a base material by supplying a coating liquid to the base material, the coating apparatus comprising:
a coating manifold for supplying the coating liquid to the base material;
a supply channel for supplying the coating liquid to the coating manifold; and
a connection channel connecting the supply channel to the coating manifold, wherein
the connection channel includes at least one branch portion, and
the at least one branch portion branches into two branch channels that are equal to each other in channel distance.

2. The coating apparatus according to claim 1, wherein
the at least one branch portion includes:
one upstream end portion forming an upstream end of each of the two branch channels; and
two downstream end portions forming respective downstream ends of the two branch channels, respectively, and
a channel distance between the upstream end portion and one of the two downstream end portions is equal to a channel distance between the upstream end portion and the other of the two downstream end portions.

3. The coating apparatus according to claim 2, wherein the upstream end portion is provided with a flow rate adjusting portion that adjusts a flow rate of each of the two branch channels.
